(19) United States
(12) Patent Application Publication
(10) Pub. No.: US 2024/0246148 A1
(43) Pub. Date: Jul. 25, 2024

(54) MAGNIFICATION OFFSET CORRECTION PROCEDURE

(71) Applicant: Nikon SLM Solutions AG, Luebeck (DE)

(72) Inventors: Jan Lukas Matyssek, Luebeck (DE); Jan Pavlita, Luebeck (DE); Karsten Neumann, Luebeck (DE)

(21) Appl. No.: 18/293,159

(22) PCT Filed: Jun. 14, 2022
(86) PCT No.: PCT/EP2022/066095

§ 371 Date: Jan. 29, 2024

(30) Foreign Application Priority Data
Aug. 17, 2021 (DE) 10 2021 121 335.5

(51) Int. Cl. B22F 10/31; B22F 10/28; B22F 10/366; B33Y 50/02

(52) U.S. Cl. CPC B22F 10/31; B22F 10/28; B22F 10/366; B33Y 50/02; B22F 2999/00

(57) ABSTRACT

A method for calibrating a position of a laser beam in an apparatus comprising at least one optical unit for directing the laser beam is provided. The at least one optical unit comprises a plurality of optical elements. The method comprises setting a first optical configuration for the plurality of optical elements of the at least one optical unit and thereby directing the laser beam onto a measurement plane with a first focus spot size, measuring a first position within the measurement plane, of the laser beam generated with the first optical configuration, setting a second optical configuration for the plurality of optical elements of the at least one optical unit and thereby directing the laser beam onto the measurement plane with a second focus spot size different from the first focus spot size, measuring a second position within the measurement plane, of the laser beam generated with the second optical configuration, and determining at least one correction value based on the measured first position and the measured second position.

The present invention relates to a method for calibrating a position of a laser beam in an apparatus comprising at least one optical unit for generating the laser beam, the at least one optical unit comprising a plurality of optical elements. The apparatus may be, without limitation, an apparatus for powder bed fusion, such as selective laser sintering and/or selective laser melting.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to radiation (e.g., laser or particle radiation) in a site-selective manner in dependence on the desired geometry of the work piece that is to be produced. The radiation penetrating into the powder layer causes heating and consequently melting or sintering of the raw material powder particles. Further raw material powder layers are then applied successively to the layer on the carrier that has already been subjected to radiation treatment, until the work piece has the desired shape and size. Powder bed fusion may be employed for the production of prototypes, tools, replacement parts, high value components or medical prostheses, such as, for example, dental or orthopedic prostheses, on the basis of CAD data. Examples for powder bed fusion techniques include selective laser melting and selective laser sintering.

Apparatuses are known for producing one or more work pieces according to the above technique. For example, EP 2 961 549 A1 and EP 2 878 402 A1, respectively, describe an apparatus for producing a three-dimensional work piece according to the technique of selective laser melting. The general principles described in these documents may also apply to the technique of the present disclosure.

When a work piece is generated by a powder bed fusion technique involving at least one laser beam, it may be desirable to produce, with one particular optical unit of the apparatus, laser spots of different laser spot sizes, depending on the intended use case. For example, a larger laser spot size may enable a quick irradiation and solidification of larger areas of a work piece. In contrast to that, a smaller laser spot size may enable a finer solidification of critical sections of the work piece, in particular a contour (also referred to as shell) of the work piece. Therefore, it is known to irradiate the shell of the work piece with a smaller laser spot size than the core. The core is typically irradiated in a so-called hatch pattern comprising, e.g., parallel scan vectors. The above method of solidifying shell and core of a work piece with different laser spot sizes is also referred to as shell-core-method.

For the above purpose of providing different laser spot sizes, it is also known to simply defocus the laser beam (i.e. moving the focus spot along the z-direction, perpendicular to the powder bed, which is in an x-y-plane, such that the focus position no longer corresponds to the z-position of the powder bed). This also leads to a broadened spot size as compared to a spot size in the exactly focused spot position (corresponding to the beam waist).

However, the present disclosure is directed to a real difference in the focus spot size at the focus position of the laser spot. As explained below in further detail, this focus spot size can be adjusted by employing a zoom optic, which involves moving at least two optical elements of the optical unit (e.g., at least two lenses). Therefore, when the present disclosure refers to a “focus spot size”, a spot size of the laser beam in its focus position is meant (also referred to as beam waist).

The projected beam spot size in a projection plane (e.g. the measurement plane) may depend on the focus spot size and a defocus of the laser beam (i.e., a focus position along the z-direction with regard to the projection plane). When the focus spot size is changed and the defocus is changed at the same time, this may even result in the same size of the projected beam spot size in the projection plane. Therefore, the size of the projected beam spot gives no information about the focus spot size.

When laser spots with different focus spot sizes are generated, it may occur that the different optical configurations of the optical elements lead to different lateral focus spot positions within a plane onto which the laser spots are directed (e.g., an x-y-plane in or parallel to a powder bed).

However, this lateral offset (i.e., offset within the x-y-plane) may lead to an offset of sections irradiated with a first focus spot size and sections irradiated with a second focus spot size. In particular, in the shell-core-method discussed above, this may lead to an offset between the shell and the core of a layer of a work piece to be generated. In case this offset is too large, the work piece may become faulty and unusable.

The person skilled in the art will appreciate that the above-described problem of different lateral positions of the laser spot may also cause problems in laser processing apparatuses different from apparatuses for powder bed fusion.

The invention is therefore directed at the object of providing a method for calibrating a position of a laser beam in an apparatus comprising at least one optical unit for generating the laser beam, the at least one optical unit comprising a plurality of optical elements, wherein the method avoids or reduces at least one of the above problems or a related problem. In particular, it is desirable to avoid a lateral offset of focus positions of laser spots having different focus spot sizes, generated by one and the same optical unit.

This object is addressed by a method according to claim 1 as well as by a computer program product according to claim 15.

According to a first aspect, a method for calibrating a position of a laser beam in an apparatus comprising at least one optical unit for directing the laser beam is provided. The at least one optical unit comprises a plurality of optical elements. The method comprises setting a first optical configuration for the plurality of optical elements of the at least one optical unit and thereby directing the laser beam onto a measurement plane with a first focus spot size, measuring a first position within the measurement plane, of the laser beam generated with the first optical configuration, setting a second optical configuration for the plurality of optical elements of the at least one optical unit and thereby directing the laser beam onto the measurement plane with a second focus spot size different from the first focus spot size, measuring a second position within the measurement plane, of the laser beam generated with the second optical configuration, and determining at least one correction value based on the measured first position and the measured second position.

The apparatus may be an apparatus for generating a three-dimensional work piece according to a powder fusion technique. More precisely, the apparatus may be an apparatus for generating a three-dimensional work piece via selective laser sintering and/or selective laser melting. In this case, the method for calibrating a position of a laser beam may be followed by the common steps of powder bed fusion techniques, such as selective laser melting or selective laser sintering. In particular, the method may involve depositing a first layer of raw material powder onto a carrier of the apparatus. The first layer (as well as the subsequent layers) may have a predefined layer thickness, wherein the layer thickness may be adjusted from layer to layer or may be fixed, depending on the type of powder depositing techniques that is used. The powder layers may be deposited by any suitable technique, wherein several methods and apparatuses for generating raw material powder layers are known in the art. After having deposited the first raw material powder layer, predefined regions of the powder are irradiated by a laser beam, according to CAD data of a work piece and/or a support structure to be produced. In this way, a first layer of a work piece to be generated may be irradiated and thereby solidified directly on the carrier or on a support structure bonded to the carrier. In a subsequent step, a second layer of raw material powder is deposited and predefined regions of said layer are irradiated and solidified. In this way, the work piece is generated layer by layer.

The optical unit may comprise a plurality of optical elements, such as at least one mirror, at least one lens, at least one grating, etc. The optical unit may either include a laser source or a laser source may be provided externally and the laser radiation may be guided to the optical element via at least one fiber or through the air or a vacuum. In this regard, in a strict sense, the optical unit may not necessarily “generate” the laser beam (in a sense that it comprises the corresponding laser source), it rather “directs” the laser beam. Directing the laser beam may comprise directing the laser beam to predefined locations on the measurement plane. For this purpose, the optical unit may comprise a scanner unit including, e.g., a pair of movable (in particular: tiltable) mirrors, such as galvanometer mirrors. The mirrors of the scanner unit may be either flat or may have focusing properties (i.e., a positive refractive power). Other techniques for scanning the laser beam to a desired location may be employed in addition or alternatively, such as at least one acousto-optic deflector, at least one piezo-actuated mirror, etc.

The optical unit may further comprise optical elements for focusing the laser beam to a desired location along the z-axis. The z-axis is defined according to a Cartesian coordinate system, wherein the measurement plane is parallel to an x-y-plane and the z-axis extends perpendicular to said x-y-plane.

The optical unit may further comprise a zoom optic allowing to change the focus spot size (i.e., the beam waist in the focus position). These functions (i.e., changing a focus position and changing a focus size) may be at least partially employed by one and the same optical components, such as one or more movable lenses (more precisely: lenses movable along the optical axis).

The expression “optical configuration” as used herein includes a predefined position of optical elements within the optical unit. In other words, in the first optical configuration, at least one optical element within the optical unit has a different position than in the second optical configuration. Here, the position may be determined with regard to a reference position within the optical unit, wherein the reference position may be fixed with regard to a housing of the optical unit. In particular, the different positions may refer to different position of one or more optical elements along the optical axis.

In other words, in order to bring the optical unit from the first optical configuration to the second configuration, at least one of the plurality of optical elements may be moved along the optical axis. For example, in order to bring the optical unit from the first optical configuration to the second configuration, at least two of the plurality of optical elements may be moved along the optical axis. The optical axis is, according to this disclosure, the optical axis of an optical system formed by the optical elements within the optical unit.

The apparatus may comprise a plurality of optical units (e.g., 2, 4, 8, or 12), wherein each of the optical units is configured to direct a laser beam to the measurement plane. In this case, each one of the plurality of optical units may include one or more of the optical elements discussed above. In particular, each optical unit may have a scanner unit, focusing optics, and zoom optics.

When the optical unit is set to the first optical configuration, it generates a focus spot in the measurement plane. The measurement plane is parallel to an x-y-plane. The measurement plane may be identical to an uppermost layer of raw material powder applied by the apparatus (so-called build plane). In this case, the raw material powder may be irradiated for calibration. Alternatively, the measurement plane may be positioned in the build plane, i.e., where the uppermost layer of raw material powder is located during the build of a three-dimensional work piece. In this case, a sensor, a foil, or a plate may be positioned on a carrier of the apparatus and the carrier is positioned along the z-axis, such that the sensor, the foil, or the plate is in the desired measurement plane. Alternatively, the measurement plane may be positioned in a same plane but next to an uppermost layer of raw material powder (e.g., in a bottom region of a process chamber of the apparatus). Further, the measurement plane may be not parallel to the x-y-plane, for example, for performing calibration, the laser beam may be deflected to a side region of the process chamber by a movable mirror. In this case, the measurement plane may be, e.g., parallel to the z-axis of the apparatus (e.g., a x-z-plane or a y-z-plane).

In a preferred embodiment, the focus spot lies in the measurement plane and has a first focus spot size, in the first optical configuration. The first focus spot size may be determined by a diameter of the focus spot. Since a focus position of the laser beam is within the measurement plane, the first focus spot size may be determined by a beam waist of the laser beam. The same applies to the focus spot size in the second optical configuration: The second focus spot may lie in the measurement plane and its size may be determined by a diameter of the focus spot. Since a focus position of the laser beam is within the measurement plane, the second focus spot size may be determined by a beam waist of the laser beam.

The first position and the second position may be measured by a sensor positioned in the measurement plane (e.g., a CCD sensor or CMOS sensor). Further, the position may be measured by a caustic measurement device in the focal position of the laser beam. The position may also be measured by a camera. The camera may be positioned in an upper region of a process chamber of the apparatus and a viewing field of the camera may be, e.g., the entire measurement plane. The camera may measure the position at the time the laser beam is directed onto the measurement plane. Additionally or alternatively, the laser beam may be used to burn an irradiation pattern (a mark) into powder (meaning melting the powder to produce a solidified structure), a foil or a plate (e.g., a photosensitive foil or anodized aluminum). In this case, the irradiation pattern may be detected by the camera in order to determine the position of the laser beam. In particular, the irradiation pattern may be detected by the camera after the laser beam has completed irradiation of the powder, foil or plate. Further, the laser beam may burn an irradiation pattern (i.e., a mark) into powder, a foil or a plate and the structure, foil or plate is afterwards removed from the apparatus and observed in an external device, e.g., by a camera. In this case, this camera determines the first and the second position. A camera used for measuring the first and second positions may at least partially use a beam path of the laser beam. In this case, the camera may be located in the optical unit.

It should be noted that the technique is not limited to measuring only one first position (for the first optical configuration) and only one second position (for the second optical configuration). Instead, a plurality of first positions and/or a plurality of second positions may be measured. In particular in the case that an irradiation pattern is irradiated by the laser beam in the first optical configuration and/or in the second optical configuration, multiple positions of this irradiation pattern may be measured.

In case a first position and a second position is measured without changing the deflection of a scanning optics (e.g., the optics center), one offset may be determined and the entire “field” is shifted for the respective magnification value. However, according to an advanced method, the measurement may be carried out at multiple locations (in a scanning field of an optical unit). In this case, there is no longer only one offset value determined for one particular magnification value but a plurality of offset values are determined, distributed over the scanning field (grid points). Between these grid points, it can be interpolated (i.e., a corresponding offset value for positions between the grid points can be interpolated based on the offset values of the grid points). This technique may be regarded as an image field correction for each magnification value. An interpolation may not only be carried out between specific magnification values, but also with regard to different deflections of a scanning optics (resulting in different nominal x-y-positions in the scanning field) of a magnification value. For determining a plurality of deflections/positions for one specific magnification value, a plurality of concentric circles may be irradiated at different nominal positions of the scanning field (i.e., wherein the centers of the circles have different nominal positions). The respective positions (and, therefore, offset values) may be detected, e.g., with an on-axis or off-axis camera system.

A sensor set may be arranged in the machine and may, e.g., observe an entire build plane or only specific regions of the build plane. Alternatively, a sensor may also be provided on or in an optical unit of the apparatus and it may partially use a beam path of the laser beam. In this case, an observed region is also movable via the scanner unit. The used sensors may be, in particular, optical sensors. The optical sensors may be sensitive to a large spectrum of wavelengths or only to a predefined spectrum, in particular a spectrum of the laser beam, or infrared (IR) radiation (optionally with a filter for blocking a wavelength of the laser in case the laser wavelength is in the detectable spectrum of the sensor).

The correction value is determined based on the measured first position, in particular the first position data set and the measured second position, in particular the second position data set. The at least one correction value may be indicative of a lateral shift (within the x-y-plane) of the laser beam between the first optical configuration and the second optical configuration, when a scanner unit of the optical unit stays in the same position. In other words, the at least one correction value may comprise x- and y-coordinates indicating said lateral shift.

As mentioned above, a plurality of first positions for the first optical configuration and a plurality of second positions for the second optical configuration may be determined. In this case, a correction value may be determined for each of the plurality of first positions. For locations that do not correspond to the plurality of first positions, correction values may be interpolated or extrapolated on the basis of the correction values for the plurality of first positions.

The correction value may be used for eliminating the lateral shift during use of the apparatus, as explained in the following.

Setting the first optical configuration for the plurality of optical elements of the at least one optical unit and/or setting the second optical configuration for the plurality of optical elements of the at least one optical unit may comprise focusing the laser beam onto the measurement plane.

Hence, the expression “directing the laser beam onto a measurement plane with a first focus spot size” of the first aspect may be replaced by “focusing the laser beam onto a measurement plane with a first focus spot size”. Further, the expression “directing the laser beam onto the measurement plane with a second focus spot size” of the first aspect may be replaced by “focusing the laser beam onto the measurement plane with a second focus spot size”. So at least one measurement of the laser beam in the measurement plane may be on the focus spot size in the measurement plane.

The method may further comprise storing a first position data set based on the measured first position, and storing a second position data set based on the measured second position, wherein the determining comprises determining the at least one correction value based on the first position data set and the second position data set.

The first position data set and the second position data set may be stored in a memory of the apparatus. For example, the first position data set may be indicative of a x-position and a y-position of the laser beam within the measurement plane. For example, a reference point within the measurement plane (zero-point) may be defined, from which the x- and y-coordinates are determined.

The method may further comprise applying the at least one correction value during use of the apparatus, such that a relationship between a position of the laser beam in the first optical configuration and a position of the laser beam in the second optical configuration is known.

For example, a control unit of the apparatus may apply the correction value when the optical unit is in the second configuration, while no correction value is applied when the optical unit is in the first configuration. Similarly, a control unit of the apparatus may apply the correction value when the optical unit is in the first configuration, while no correction value is applied when the optical unit is in the second configuration. These options may be used when the correction value indicates a lateral shift of the laser beam in the measurement plane between the first and the second configuration. However, a correction value may be calculated for the first optical configuration and for the second optical configuration, with regard to a reference point within the measurement plane. In this case, a correction value may be applied both in the first optical configuration and in the second optical configuration. In any case, the correction value can be used for determining a position of the laser beam in the second optical configuration as compared to the first optical configuration, such that the laser beam can be directed to a desired location in an x-y-plane, for each of the optical configurations.

The at least one correction value may be applied by a control unit of the apparatus at the time a three-dimensional work piece is generated. For example, the position and/or steering data provided to the scanner mirrors may be adapted such that the at least one correction value is considered. However, also the build data of the work piece may be modified in order to consider the at least one correction value. In this case, the modification may be performed by an external device (e.g., a computer).

Further, a correction of the lateral offset may be achieved by moving at least one optical element (e.g., along the optical axis and/or perpendicular to the optical axis), by rotating at least one optical element around one or more axes perpendicular to the optical axis, and/or by moving the optical unit with regard to a build plane of the apparatus.

In addition to the first and second optical configurations, at least a third optical configuration may be considered and a respective position may be measured. In this way, e.g., at least 4, at least 6, at least 8, or at least 10 optical configurations of the optical unit may be considered. For each optical configuration, a correction value may be stored. Each of the optical configurations may represent a magnification factor of the focus spot size. For example, positions of the laser spot may be measured for a plurality of integer magnification values (such as 1, 2, 3, 4, 5, 6, 7, and 8) or non-integer magnification values.

At locations that do not correspond to the considered optical configurations (i.e., the measured positions for the respective focus spot sizes), it may be interpolated or extrapolated as discussed in the following.

The method may further comprise determining at least one correction value for a third optical configuration by performing an interpolation or extrapolation on the basis of the at least one correction value.

A linear interpolation and/or a linear extrapolation may be applied. More precisely, it may be assumed that between two known correction values, a linear dependency exists between the focus spot size (e.g., magnification factor) and the lateral shift in the x-y-plane. Further, a higher order interpolation and/or extrapolation may be considered.

An interpolation and/or extrapolation may be applied on the basis of a change of a focus spot size (e.g. a magnification factor). Alternatively an interpolation and/or extrapolation may be applied on the basis of a change of a position of an optical element (e.g. a movement distance).

Setting the second optical configuration for the plurality of optical elements of the at least one optical unit may comprise changing a position of at least two optical elements, in particular, of at least two lenses.

In other words, in order to bring the optical unit from the first configuration to the second configuration, at least two optical elements may be moved. In particular, at least two lenses may be moved along the optical axis. Each of the two lenses may have positive refractive power. The at least two lenses that are moved may be in a telescope arrangement. Further, the optical unit may comprise more than two lenses, for example four lenses. The four lenses may be arranged in a double telescope arrangement. In this case, e.g., at least four lenses may be moved in order to bring the optical unit from the first optical arrangement to the second optical arrangement.

The method may further comprise, while in the first optical configuration, irradiating the measurement plane according to a first irradiation pattern, and, while in the second optical configuration, irradiating the measurement plane according to a second irradiation pattern.

Therefore, measuring a position of the laser beam may be part of measuring a position of an irradiation pattern and/or measuring a position of one or more predefined points within an irradiation pattern. For example, in case the irradiation pattern comprises two crossing lines (e.g., a cross), a position of an intersection point may be determined. In general, measuring the first and/or the second position may comprise measuring an intersection point of two lines of a corresponding irradiation pattern.

The first irradiation pattern and the second irradiation pattern may be irradiated onto at least one sensor positioned in the measurement plane.

The sensor may provide electric signals indicative of irradiated positions on the sensor, which may be further evaluated by a control unit of the apparatus. For example, the sensor may provide two-dimensional image data, which may be further evaluated by the control unit in order to determine the respective positions. The sensor may be a two-dimensional sensor, such as a CCD sensor or a CMOS sensor.

The first irradiation pattern and the second irradiation pattern may be projected or burnt onto a foil or plate or powder layer positioned in the measurement plane.

As an alternative to a sensor positioned in the measurement plane, powder, a foil or plate may be positioned in the measurement plane. The irradiation pattern is projected onto the powder, foil or plate such that the irradiation pattern can be observed e.g. by a camera or human eye during the projection. Just to be clear, projecting the laser radiation means that no permanent changes on the powder, foil or plate occur.

As an alternative to a sensor positioned in the measurement plane, powder, a foil or plate may be positioned in the measurement plane. The irradiation pattern is burnt into the powder, foil or plate such that the irradiation pattern is visible after the irradiation has stopped. In other words, the laser beam leaves a visually detectable pattern in the powder, foil or plate, e.g., via discoloration or visible or haptic structure. For example, the foil may be photosensitive in a sense that the laser reacts with the foil, which leads to a discoloration. Alternatively, the laser may burn holes into the foil, such that the irradiation pattern comprises one or more holes. The plate may be coated or plated, wherein the laser beam leaves a mark in the coating or plating, e.g., by burning the coating or plating. Such foils or plates used for calibrating laser beams are well known in the art. A structure may be produced due to irradiation of one or more layers of powder material.

The method may further comprise, before the step of measuring the first position and before the step of measuring the second position, observing the first irradiation pattern and the second irradiation pattern with the human eye and, based on the observing, deciding that the step of measuring the first position and the step of measuring the second position shall be carried out.

For example, the foil or plate may be visually observed. Only in case the observing person detects irregularities in the irradiation pattern, the first and second positions are measured. In case the observing person detects no irregularities, the optical unit is considered to be calibrated and there is no need for further investigation (i.e., by measuring the exact positions of the laser beams in the respective optical configurations). For example, the observing person may decide that the steps of measuring the first and second position shall be carried out in case the observing person identifies an asymmetry in the irradiation pattern. In an alternative, firstly, an irradiation pattern is irradiated, which is quickly irradiated and can be easily observed by the human eye. In case the person determines that further measurement is necessary, an irradiation pattern is irradiated, which is optimized for detailed computer-aided evaluation.

The first irradiation pattern may comprise a first circle and the second irradiation pattern may comprise a second circle concentric to the first circle.

This irradiation pattern may be space-saving. Further, deviations between the different optical configurations may be easy to determine by the human eye (shift or deformation of one circle with regard to another circle). The irradiation pattern may comprise one circle for each optical configuration, wherein the circles are concentric and at least three optical configurations (e.g., 9 optical configurations) are considered.

The apparatus may comprise a plurality of optical units and a set of concentric circles may be irradiated for each of the optical units.

Hence, for each optical unit, one set of concentric circles may be projected or burnt onto powder, a foil or plate, e.g., for visual inspection and/or inspection by a camera.

The second focus spot size may be larger than the first focus spot size by a factor of at least 1.5, at least 2, at least 3, at least 4, at least 5, at least 6, at least 7, or at least 8.

The focus spot size may be determined by a diameter of the focus spot in its focal point. In other words, the focus spot size may correspond to a beam waist. The projected beam spot size in the measurement plane may depend on the focus spot size and a defocus of the laser beam.

The apparatus may be an apparatus for generating a three-dimensional work piece via selective laser sintering and/or selective laser melting.

In this case, the apparatus may comprise typical elements of such a machine, such as a process chamber, a powder application device, a carrier movable along the z-axis within a build cylinder, etc.

The method may further comprise irradiating a contour of a layer of a three-dimensional work piece with the first focus spot size, and irradiating a core portion of the three-dimensional work piece within the contour with the second focus spot size larger than the first focus spot size. A position of the laser beam for irradiating at least one of the contour and the core portion may be corrected by the at least one correction value.

In this case it can be ensured that an area within the contour (shell) is completely solidified by the laser beam having the second focus spot size.

The method steps of the method according to the first aspect may be carried out in the indicated order. However, the order of the steps shall not be limited to the indicated order. For example, the method may be carried out according to the following order: setting a first optical configuration, setting a second optical configuration, measuring a first position, measuring a second position, and determining at least one correction value. The above order of steps may be particularly useful in case an irradiation pattern is burnt into a foil or a plate. In this case, firstly, the irradiation steps may be carried out and subsequently, the measuring steps are carrier out. In another example the measurement of the corresponding position may be carried out during or directly afterwards setting an optical configuration.

In case the measurement is carried out at multiple locations (in a scanning field of an optical unit) the method according to the first aspect may be carried out in the indicated order at one location before carrying out the method at the next location. Alternatively, the method may be carried out in the order that the first optical configuration is set and the first positions are measured at a set of locations or every location before the second optical configuration is set and the second positions are measured at the set of locations or every location.

According to a second aspect, a computer program product is provided, which, when carried out by a processor of an apparatus comprising at least one optical unit for generating a laser beam, the at least one optical unit comprising a plurality of optical elements, instructs the apparatus to carry out a method according to the first aspect.

The computer program product may be stored on a computer-readable carrier.

Preferred embodiments of the invention are described in greater detail with reference to the appended schematic drawings, wherein

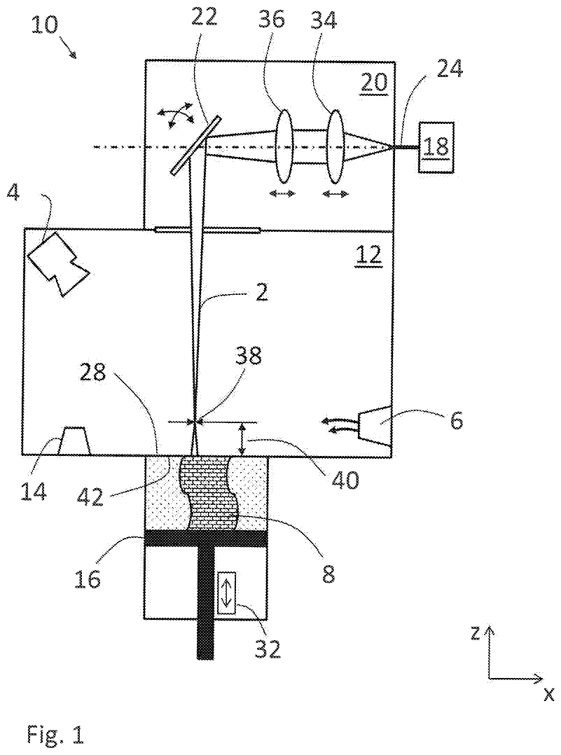

FIG. 1 shows a schematic representation of an apparatus for producing a three-dimensional work piece that may be used for carrying out the methods according to the embodiments described herein;

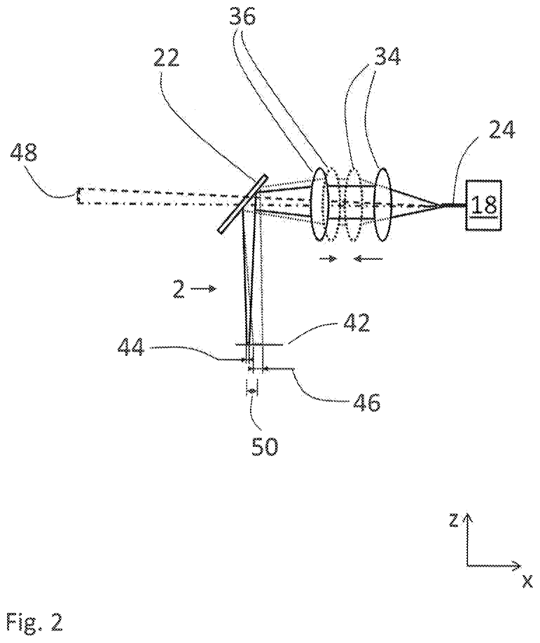

FIG. 2 shows two exemplary optical configurations of the optical unit that may be used according to embodiments of the present disclosure;

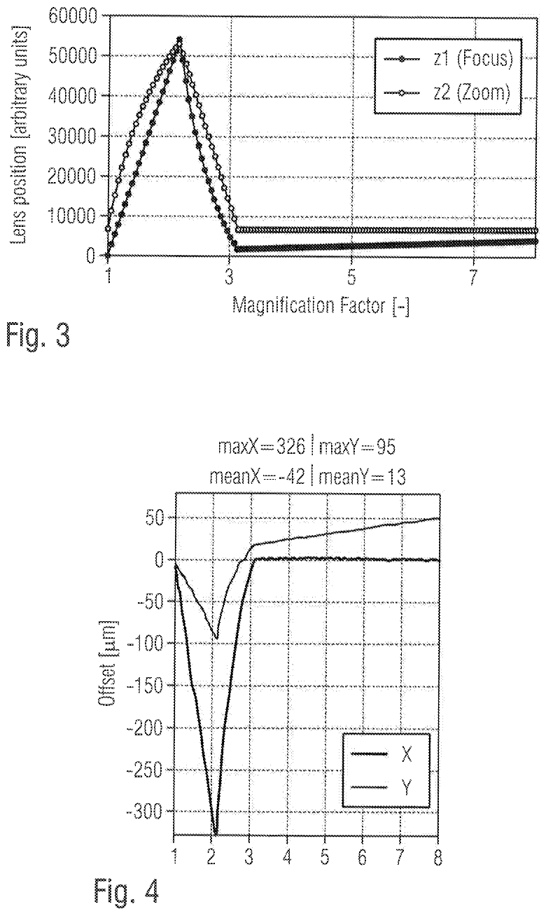

FIG. 3 shows a diagram of lens positions of two lenses of the optical unit for different optical configurations;

FIG. 4 shows a diagram for one optical unit, wherein the diagram indicates a lateral offset of a position of the respective laser beam for different optical configurations;

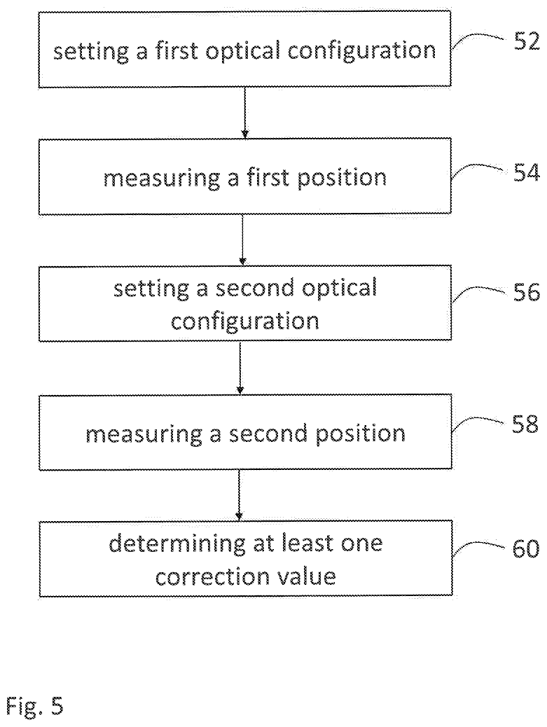

FIG. 5 shows a flow chart of a method according to an embodiment of the present disclosure;

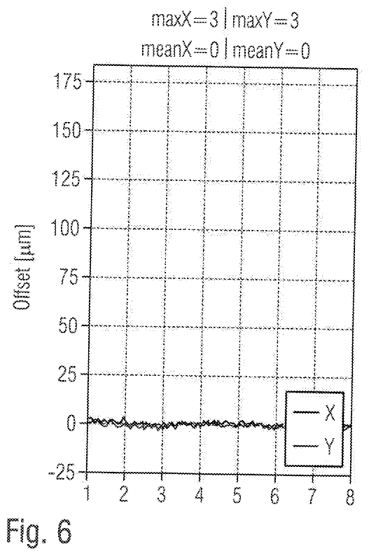

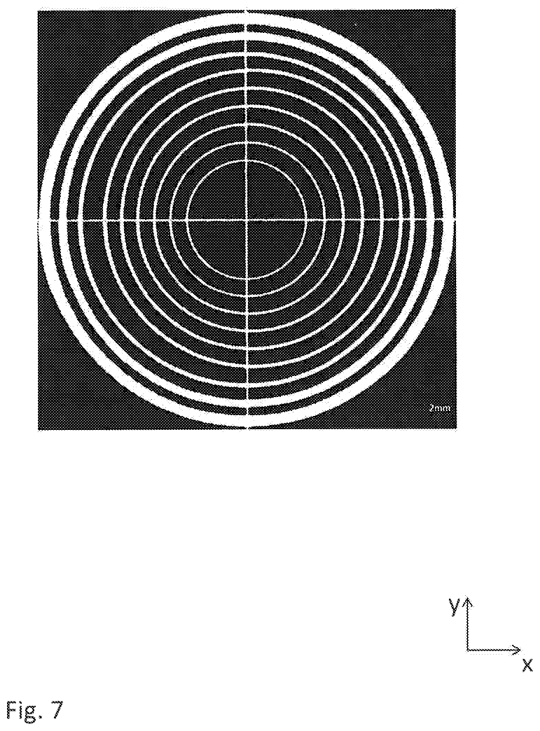

FIG. 6 shows a diagram of one optical unit, wherein the diagram indicates a lateral offset of a position of the respective laser beam for different optical configurations, after the at least one correction value has been applied;

FIG. 7 shows an exemplary irradiation pattern with concentric circles, wherein each circle represents one optical configuration; and

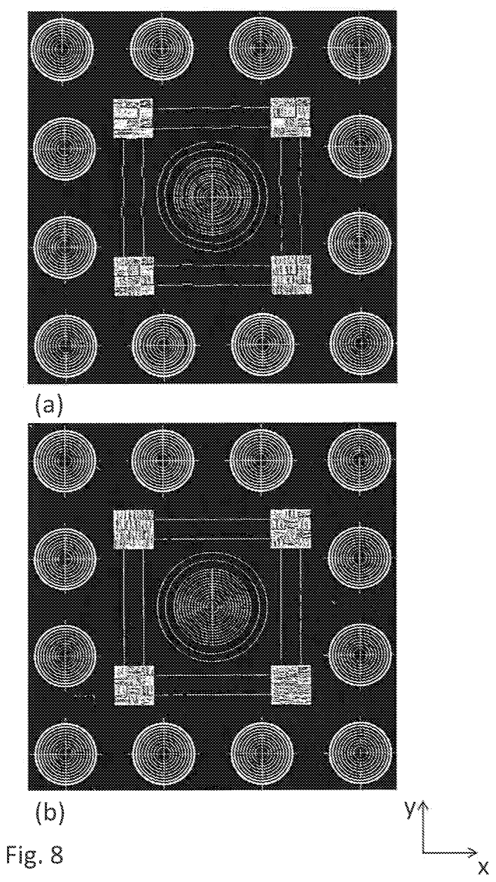

FIG. 8 (a) shows irradiation patterns for calibrating 12 optical units, before calibration, and (b) shows irradiation patterns for calibrating 12 optical units, after calibration.

FIG. 1 shows a schematic representation of an apparatus 10 for producing a three-dimensional work piece 8, which is suitable for carrying out the methods according to the present disclosure. However, the present disclosure shall not be limited to methods performed by the exact apparatus of FIG. 1. The methods may be carried out by any suitable apparatus. For example, such an apparatus may be an apparatus for selective laser melting or an apparatus for selective laser sintering, wherein one or more laser beams may be used for selectively irradiating and solidifying subsequent layers of raw material powder. Further, the calibration technique of the present disclosure is not limited to apparatuses for powder bed fusion. The person skilled in the art will appreciate that the calibration technique discussed in the present disclosure can be applied to a variety of laser processing techniques involving an apparatus comprising an optical unit for generating laser beams with different focus spot sizes.

For the present disclosure, it is assumed that the techniques of powder bed fusion are well known to the skilled person and, therefore, the details of these techniques will not be discussed in detail. The apparatus 10 for carrying out a process of selective laser melting as described below may serve as an example. Typical features of powder bed fusion are that a raw material powder is applied in layers and each layer is selectively irradiated and solidified in order to generate one layer of a work piece to be produced. After removing excess powder, and after optional steps of post processing (e.g., removing one or more support structures), the final work piece is obtained.

FIG. 1 shows an apparatus 10 for producing a three-dimensional work piece 8 by selective laser melting. The apparatus 10 comprises a process chamber 12. The process chamber 12 is sealable against the ambient atmosphere, i.e. against the environment surrounding the process chamber 12. A powder application device 14, which is arranged in the process chamber 12, serves to apply a raw material powder onto a carrier 16. A vertical movement unit 32 is provided, such that the carrier 16 can be displaced in a vertical direction so that, with increasing construction height of the work piece 8, as it is built up in layers from the raw material powder on the carrier 16, the carrier 16 can be moved downwards in the vertical direction.

Since the movability of the carrier 16 by means of the vertical movement unit 32 is well known in the field of selective laser melting, it will not be explained in detail herein. As an alternative to the movable carrier 16, the carrier 16 may be provided as stationary (or fixed) carrier (in particular, with regard to the vertical z-direction), wherein the irradiation unit 20 (see below) and the process chamber 12 are configured to be moved upwards during the build process (i.e., with increasing construction height of the work piece 8). Further, both the carrier 16 and the irradiation unit 20 may be individually movable along the z-direction.

A carrier surface of the carrier 16 defines a horizontal plane (an x-y-plane), wherein a direction perpendicular to said plane is defined as a vertical direction or build direction (z-direction). Hence, each uppermost layer 28 of raw material powder extends in a plane parallel to the horizontal plane (x-y-plane) defined above.

The apparatus further comprises a gas inlet 6 for supplying an inert gas (e.g., argon) into the process chamber 12. A gas outlet (not shown) may be provided, such that a continuous stream of gas may be generated through the process chamber 12 by implementing a gas circuit.

Further, a camera 4 is arranged in the process chamber 12, for observing a laser beam 2 directed by the optical unit 20 towards the powder bed during operation and/or for observing irradiated regions after irradiation by the laser beam 2. Further, by blocking a wavelength of the laser beam 2 with a respective optical filter, only the heat radiation of a generated melt pool may be observed. The camera 4 may be part of a melt pool observation device. In the embodiment shown in FIG. 1, the camera 4 has its own optical system configured to generate an image of an uppermost layer 28 of the raw material powder. The camera 4 therefore may include focusing optics and/or zoom optics. In particular, in the embodiment shown in FIG. 1, the camera 4 is used to determine a position of the laser beam 2 in a measurement plane 42. The measurement plane 42 corresponds to a plane of the uppermost layer 28 of raw material powder arranged on the carrier 16.

The apparatus 10 further comprises an optical unit 20 (also referred to as irradiation unit) for selectively irradiating the laser beam 2 onto the uppermost layer 28 of raw material powder applied onto the carrier 16. By means of the optical unit 20, the raw material powder applied onto the carrier 16 may be subjected to laser radiation in a site-selective manner in dependence on the desired geometry of the work piece 8 that is to be produced.

The optical unit 20 comprises a scanning unit 22 configured to selectively irradiate the laser beam 2 onto the raw material powder applied onto the carrier 16. The scanning unit 22 is controlled by a control unit (not shown) of the apparatus 10. The scanning unit 22 may comprise one mirror tiltable with regard to two perpendicular axes. Alternatively, the scanning unit 22 may comprise two tiltable mirrors, each configured to be tilted with regard to a corresponding axis. The tiltable mirrors may be, e.g., galvanometer mirrors.

The optical unit 20 is supplied with laser radiation from a laser beam source 18. The laser beam source 18 may be provided within the optical unit 20 or outside the optical unit 20, as shown in FIG. 1. In the latter case, the laser beam is generated by the laser beam source 18 and guided into the optical unit 20 via an optical fiber 24. Alternatively, the laser beam may be guided into the optical unit 20 through the air or through a vacuum, e.g., by using one or more mirrors.

From the laser beam source 18, the laser beam is directed to the scanning unit 22. The laser beam source 18 may, for example, comprise a diode pumped Ytterbium fiber laser emitting laser light at a wavelength of approximately 1070 to 1080 nm.

The optical unit 20 further comprises two lenses 34 and 36, which are configured to focus the laser beam 2 onto a desired focus position 38 along the z-axis. In the embodiment shown in FIG. 1, both lenses 34 and 36 have positive refractive power. The lens 34 further upstream of the beam path is configured to collimate the laser light emitted by the fiber 24, such that a collimated or substantially collimated laser beam is generated. The lens 36 further downstream of the beam path is configured to focus the collimated (or substantially collimated) laser beam onto a desired z-position.

In this regard, lens 36 may be regarded as a focus lens, since a movement of said lens 36 along the beam path leads to a shift of the focus position 38 with regard to the z-axis. Lens 34 may be regarded as a zoom lens, since a movement of said lens 34 along the beam path leads to a change in focus spot size at the focus position 38. However, as discussed with regard to FIG. 2 in more detail, in order to change the focus spot size while maintaining a position of the focus position 38, a movement of both lenses 34 and 36 is required.

It is further noted that the arrangement of lenses 34 and 36 shown in FIG. 1 is only one of many possible examples of optical arrangements within an optical unit. For example, instead of the single telescope arrangement shown in FIG. 1, a double telescope arrangement may be provided, with two lenses per telescope. It is therefore noted that the optical unit 20 may comprise an arbitrary number of optical components, such as lenses, which may be fixed or movable, e.g., movable along the optical axis. However, at least two of the lenses are provided movable, in order to fulfil the functions of focusing and zooming, as described above.

It is further noted that a change of a diameter of a laser spot generated in the uppermost layer 28 could also be achieved by moving the focus position 38 out of the layer 28, such that a non-focused beam impinges on the layer 28. In other words, a change of a diameter of a laser spot generated in the layer 28 could also be achieved by “merely” defocusing, i.e., by merely moving the focus lens 36 without moving zoom lens 34. This situation is shown in FIG. 1, where a defocused laser beam 2 impinges on the layer 28 and the laser beam 2 is defocused by a defocus 40.

In other words, a focus position 38 of the laser beam 2 is not within the layer 28. In this situation, the laser beam 2 is not “focused onto” the layer 28. In case a measurement plane 42 is positioned in the layer 28, the laser beam 2 is not focused onto the measurement plane 42.

The present disclosure is rather directed to the situation that the focus spot size in the focus position 38 is actually changed, i.e., a beam waist of the focused laser beam 2 is changed. In a preferred embodiment the focus position remains in the measurement plane 42. In order to achieve this, at least two lenses are moved, i.e., the two lenses 34 and 36 are moved. Additionally the spot size may also be changed due to a combination of changing the beam waist (focus spot size) and the focus position (defocus).

Further details of the optical configurations for the different focus spot sizes are shown in FIG. 2.

In FIG. 2, the solid line represents a first optical configuration, whereas the dotted line represents a second optical configuration. In the first optical configuration, a smaller laser spot is generated than in the second optical configuration. More precisely, a focus spot size 44 in the first optical configuration is smaller than a focus spot size 46 in the second optical configuration. In both configurations, the laser beam 2 is focused onto a measurement plane 42 (e.g., the uppermost layer 28 of FIG. 1). In order to bring the optical unit 20 from the first optical configuration to the second optical configuration, it is necessary that both lenses 34 and 36 are moved along a direction of the optical axis. In view of the above, a position of both lenses 34 and 36 for providing a desired focal spot size in a desired measurement plane 42 are predefined and can be stored in a memory of a control unit configured to control a movement of both lenses 34 and 36 (see also FIG. 3).

FIG. 2 further shows a problem that may occur when the focus spot size is changed while maintaining the focus position 38 within the same measurement plane 42.

The lenses 34 and 36 may not be perfectly aligned with regard to the optical axis. In other words, for the following discussion, an optical axis along the x-axis of FIG. 2 may be considered, wherein this optical axis is defined by an orientation of the fiber 18. However, the lenses 34 and 36 may not be perfectly aligned with regard to this optical axis. Therefore, also a movement of the lenses 34 and 36 “along the optical axis” will not be perfectly parallel to the optical axis. Therefore, by moving the lenses 34 and 36 “along the optical axis”, the focus position 38 is not only changed with regard to the z-direction (as desired), but also with regard to the x-y-plane, i.e., within the measurement plane 42. In other words, a lateral shift of the focus position 38 occurs. This problem is indicated in FIG. 2 by the error angle 48 with regard to the optimum. In an ideal case, the error angle 48 would be zero and all optical elements would be perfectly positioned with matching optical axes.

In addition to the effect described above, thermal effects (e.g., thermal lens) may contribute to the effect of a lateral shift of the focus position 38.

The resulting lateral shift is indicated by reference sign 50.

When the optical arrangement is optimized, e.g., for an optical configuration related to a magnification value of 1 (smallest laser focus size), the lateral shift caused by all other optical configurations (related to higher magnification values) may be considered with regard to the position of the laser beam 2 at magnification value 1.

Therefore, the larger the displacement of a lens 34, 36 from the optical configuration for magnification value 1 is, the larger the lateral offset 50 is expected to be (with regard to the laser position in the first optical configuration). This is the case since a zero point for determining the lateral offset 50 is defined for the optical configuration of magnification value 1.

FIG. 3 shows displacements for the zoom lens 34 and the focus lens 36, wherein the lens position is normalized to zero for magnification factor 1. In FIG. 3, the upper curve shows the lens position of the zoom lens 34 and the lower curve shows the lens position of the focus lens 36, both in arbitrary units. As can be seen from FIG. 3, a maximum displacement for both lenses occurs around magnification factor 2.

In FIG. 4, the corresponding measured lateral offsets are indicated, for one exemplary optical unit 20 of an apparatus 10. The lateral offset within the x-y-plane (measurement plane) is split up into components along the x-axis and along the y-axis. Further, the offset is normalized to zero for the optical configuration corresponding to magnification value 1.

From FIG. 4 it can be seen that the respective optical unit exhibits the above-described problem of lateral shift of the focus position, when different magnification values (corresponding to different optical configurations) are set in the optical unit. The lateral offset (both in the x- and y-direction) has a maximum at a magnification value of around 2, as can be expected from the above discussion with regard to the lens positions shown in FIG. 3, having the maximum displacement of both lenses around that value.

In the following, a method will be discussed, which is directed to eliminating or at least mitigating the lateral offset shown in FIG. 4.

FIG. 5 shows a method for calibrating a position of a laser beam 2 in an apparatus 10 comprising at least one optical unit 20 for directing the laser beam 2, according to an embodiment of the present disclosure. The at least one optical unit 20 comprises a plurality of optical elements (such as lenses). As an example, the apparatus 10 discussed with regard to FIG. 1 may be used for carrying out the method of FIG. 5.

According to a first step 52, the method comprises setting a first optical configuration for the plurality of optical elements of the at least one optical unit 20 and thereby directing (in particular, focusing) the laser beam 2 onto a measurement plane 42 with a first focus spot size 44. According to a second step 54, the method comprises measuring a first position within the measurement plane 42, of the laser beam 2 generated with the first optical configuration, and preferably storing a first position data set based on the measured first position. According to a third step 56, the method comprises setting a second optical configuration for the plurality of optical elements of the at least one optical unit 20 and thereby directing (in particular, focusing) the laser beam 2 onto the measurement plane 42 with a second focus spot size 46 different from the first focus spot size 44. According to a fourth step 58, the method comprises measuring a second position within the measurement plane 42, of the laser beam 2 generated with the second optical configuration, and preferably storing a second position data set based on the measured second position. According to a fifth step 60, the method comprises determining at least one correction value based on the measured first position and the measured second position.

The steps 52 to 60 of the method may be carried out in the order indicated above. Hence, a position of the laser beam may be measured each time after a corresponding optical configuration has been set and a corresponding laser beam has been irradiated. However, the method may also be carried out such that, firstly the optical configurations are set and the measurement plane 42 is irradiated and secondly, the positions are measured. In this case, an order of steps may be 52, 56, 54, 58, and 60.

According to the present calibration technique, there are different ways, how the laser beam 2 can be irradiated onto the measurement plane 42 and how the positions can be determined.

According to a first example, the laser beam 2 is irradiated onto the uppermost powder layer 28 and the position of the laser beam (i.e., first and second position) is determined by a camera such as the camera 4 of FIG. 1. In this case, the position may be determined at the time the laser beam 2 irradiates the powder layer 28 (with an energy density high enough to melt the powder, or only high enough to temporarily heat the powder, or so low to cause no effect on the powder) or after the laser spot 2 has burnt a predefined irradiation pattern into the powder layer 28.

According to a second example, a sensor is positioned in the measurement plane 42, e.g., in the plane where the uppermost powder layer 28 is irradiated during a build process of the apparatus 10, or in a parallel plane with a certain offset above or below the plane of the powder layer. For this purpose, the sensor may be positioned on the carrier 16 and moved upwards or downwards until it is positioned in the plane of the uppermost powder layer 28. The sensor may be a two-dimensional sensor, such as a CCD sensor or a CMOS sensor. Also in the case a sensor is used, the sensor may either directly output position information of the present irradiation or it may output two-dimensional image data, based on which the positions are determined after irradiation.

According to a third example, the laser beam 2 is irradiated onto a foil or a plate defining the measurement plane 42. The foil or the plate may be positioned in a plane, where the uppermost powder layer 28 is irradiated during a build process of the apparatus 10. For this purpose, the foil or the plate may be positioned on the carrier 16 and moved upwards or downwards until it is positioned in the plane of the uppermost powder layer 28. The foil may be a photosensitive foil. The plate may comprise, e.g., anodized aluminum. In a preferred case, the laser beam 2 leaves a visible mark in the foil or the plate, according to an irradiation pattern irradiated onto the foil or plate. After irradiation, the irradiation pattern may be observed by a human eye and/or by a camera. Alternatively the laser may only be projected onto the foil or plate and observed by e.g. a camera during projection. The positions of the laser beam 2 may be determined with the help of a computer, i.e., with the help of image analysis software.

According to a fourth example, the sensor or the foil or plate may be positioned in a side region of the process chamber 12, wherein the laser beam 2 is deflected by a movable mirror. For carrying out the measurement and calibration, the movable mirror is moved into the laser beam 2. When the measurement and calibration is finished, the movable mirror may be moved out of the laser beam 2 again. In this case, the measurement plane is not parallel to the x-y-plane but may be, e.g., parallel to the z-axis. For example, the measurement plane may be a x-z-plane or a y-z-plane.

According to a fifth example, the sensor or the foil or plate may be positioned next to the uppermost layer 28 of raw material powder, i.e., on the ground in a bottom region of the process chamber 12. A plane in which the sensor or the foil or plate are arranged may correspond to a plane of the uppermost layer 28.

In the following, it is explained, how the steps of the method of FIG. 5 can be carried out by the device 10 of the embodiment shown in FIG. 1. According to the embodiment explained in the following, the method is carried out in the order of steps 52, 56, 54, 58, and 60.

Step 52: A first optical configuration of the lenses 34 and 36 within the optical unit 20 is preferably set, such that the laser beam 2 is focused onto the measurement plane 42. The optical configuration refers to a predefined position of the lenses 34 and 36 along the optical axis. For setting the optical configuration, the lenses may be moved by corresponding actuators, which are controlled by ta control unit of the apparatus 10. The position of lenses 34 and 36 is stored in the control unit, e.g., in the form of a look-up table. For setting the positions of the lenses 34, 36, a desired magnification value may be chosen (e.g., magnification value 1) and the corresponding lens positons may be read from the look-up table. For example, FIG. 3 shows a relationship between a desired magnification value and the corresponding lens positions of lenses 34 and 36. The position information of the lenses 34 and 36 may be updated, e.g., after a calibration of the focus spot position 38 and/or of the magnification value has been carried out. However, details of this calibration are well known to the person skilled in the art and are therefore not described herein in more detail.

As indicated above, there are different possibilities of carrying out the method, in particular with regard to how the position of the laser beam 2 is measured. In the following, it will be focused on an example using a photosensitive foil, according to the above third example. However, also the other possibilities according to the first to fifth example can be realized with the apparatus 10 of FIG. 1, as will be appreciated by the skilled person.

The optical configuration is preferably set such that the laser focus position 38 is within the measurement plane 42, which is defined at a position, where an uppermost layer 28 of raw material is provided during a build process of the apparatus 10. Hence, the photosensitive foil is placed onto the carrier 16 and the carrier is moved (upwards or downwards) until the foil is in the desired measurement plane 42.

The scanning unit 22 is controlled such that a predefined first irradiation pattern is irradiated onto the foil while the irradiation unit 20 is in the first optical configuration. Examples of possible irradiation patterns will be explained with reference to FIGS. 7 and 8. For example, the irradiation pattern for the first optical configuration may be a first circle with a first radius.

Step 56: After the irradiation pattern for the first optical configuration is completed, a second optical configuration is set in the optical unit 20. For example, a second magnification value may be chosen (such as magnification value 5) and the lenses 34 and 36 are moved to predefined positions for the desired magnification value (based, e.g., on the data shown in FIG. 3). The laser focus position 38 may be maintained in the measurement plane 42. In other words, as shown in FIG. 2, only the “zoom” of the laser beam 2 may be changed but not its focus position 38. The focus position 38 and, therefore, the beam waist may stay in the measurement plane 42. Alternatively, a desired magnification may be achieved due to a combination of changing the beam waist and the focus position.

In this second optical configuration, a second irradiation pattern is irradiated and thereby burnt into the foil. The second irradiation pattern may be a second circle concentric to the first circle but with a different (e.g., larger) radius.

In the following optional steps, further optical configurations are set and corresponding irradiation patterns are burnt into the foil (e.g., as concentric circles).

Further, in case the apparatus 10 comprises more than one optical unit 20, the other optical unit(s) may perform the same steps as discussed above either simultaneously to the optical unit 20 or one optical unit after the other.

After steps 52 and 56 discussed above, an optional step may follow. In this optional step, the foil is inspected by a human eye of a person (e.g., of an operator of the apparatus 10). In case the person detects any irregularities in the irradiated irradiation patterns (e.g., asymmetries, unexpected line thickness, unexpected degree of discoloration, etc.), it is decided that the foil is further inspected by performing detailed measurements of laser positions as discussed above. However, in case the person does not detect any visually perceptible irregularities, it may be decided that the optical unit(s) 20 of the apparatus are sufficiently calibrated and no further measurements are performed. In this case, a build process of a three-dimensional work piece can be started. The inventors discovered, that irradiation patterns comprising concentric circles are advantageous for inspection by a human eye, and irregularities can be much easier detected than e.g. a pattern of parallel stripes.

Step 54: The foil is observed with a camera, e.g., with the camera 4 of the apparatus 10 or with an external camera and a two-dimensional image is generated. Based on the two dimensional image, a position of the first irradiation pattern is determined, e.g., with regard to a reference point on the foil (e.g., with regard to the corners of the foil or with regard to one or more reference mark burned into the foil). In this way, a position of the laser beam 2 is determined, when it was irradiated onto the foil in the first optical configuration. The process of measuring this position may be performed fully automatically vie image analysis software or an operator may inspect the recorded image and may set respective markers in the two-dimensional image data. A first position data set is stored, indicative of the first position.

Step 58: Similar to the measurement of the first position for the first optical configuration, a second position for the second optical configuration is measured by measured a position of the second irradiation pattern. It is noted that it may be sufficient to measure the position of the first irradiation pattern and the second irradiation pattern with respect to each other (and not with respect to a “global” reference point on the foil). In this case, the calibration may be performed and normalized, e.g., to the first optical configuration. A second position data set is stored, indicative of the second position.

In case more than the first and second optical configuration shall be considered, also positions of the additional irradiation patterns are determined.

Step 60: When the position for all optical configurations have been measured, at least one correction value is determined based on the first and second position data set. For example, a lateral offset (within the x-y-plane) is determined between an expected laser position in the first optical configuration and an expected laser position in the second optical configuration. For example, the expected laser position may be a center of the circle corresponding to the respective irradiation pattern. The offset may be indicated by an x-value and a y-value. The offset is stored in a memory of the control unit of the apparatus 10. For example, offset values may be stored with regard to a position of the first optical configuration. In this case, when the first optical configuration is used, no offset is applied. However, when a laser beam in the second optical configuration is irradiated, the offset is applied to position data provided to the scanner unit 22, such that a desired position of the laser beam 2 within the x-y-plane (measurement plane 42) corresponds to the irradiated position. Similarly, offset values for other optical configurations (e.g., a third optical configuration, a fourth optical configuration, etc.) may be stored in the control unit.

Alternatively, a global reference point on the foil (and, therefore, in the measurement plane 42) may be used and offset values with regard to the reference point may be applied for all optical configurations (i.e., also for the first optical configuration).

Further, when an optical configuration is set for irradiation, but no corresponding offset (correction value) is stored in the memory for this optical configuration, a correction value may be determined via interpolation. For example, a linear dependency between magnification value and offset may be assumed.

FIG. 6 shows a diagram for an optical unit 20 after the correction value has been applied. The diagram is similar to that of FIG. 4 (which shows the situation before the calibration). As can be seen from FIG. 6, the lateral offset for the different magnification values could be almost entirely removed (apart from unavoidable noise) for the optical unit 20.

FIG. 7 shows an example of an irradiation pattern for one optical unit 20 of the apparatus 10. The irradiation pattern has been irradiated by 9 different optical configurations of the optical unit 20. Firstly, a vertical line and a horizontal line forming a cross are written with magnification value 1. A circle with a first radius is written also with magnification value 1, wherein a center of the circle corresponds to a crossing point of the vertical line and the horizontal line. After that, subsequently, for each optical configuration, a circle is irradiated, wherein all circles are concentric with regard to the first circle. In the example of FIG. 7, the magnification values used for the individual circles correspond to 1, 1.3, 1.5, 1.8, 2, 2.5, 3, 6, and 8.

As can be seen, the presence of an irregularity in the example of FIG. 7 can be easily observed by human eye, giving the indication for a further detailed measurement.

Based on the irradiation pattern shown in FIG. 7, the correction values for the individual optical configurations can be easily determined, e.g., by comparing positions of crossing points of the circles with the horizontal line and the vertical line written under optical configuration with magnification value 1.

FIG. 8 (a) shows an irradiation pattern for 12 optical units, wherein sets of concentric circles are provided for each optical unit, as discussed above with regard to FIG. 7. As can be directly seen from FIG. 8 (a) without performing detailed measurements, some of the circles are not perfectly concentric and appear to be shifted in the x-y-plane. Therefore, a lateral offset exists for the corresponding optical units, which therefore need to be calibrated.

FIG. 8 (b) shows an irradiation pattern after calibration, wherein no irregularities in the sets of concentric circles are visually perceptible.

The pattern shown in FIGS. 8 (a) and (b) further includes boxes, which are filled with a hatch pattern from a corresponding optical unit 20 in order to observe differences in optical power (or defocus). In case one or more of these white boxes has a different degree of discoloration than the other boxes, this is a hint that a laser power (or focus position) of the corresponding optical unit 20 is misaligned.

The pattern shown in FIGS. 8 (a) and (b) further comprises a set of straight and curved lines, wherein each line is written by one optical unit 20 of the apparatus 10. A mismatch between the optical units (i.e., a lateral shift in the x-y-plane) can therefore easily be detected and corrected, when the individual lines do not form one continuous line.

The measurement described above can be carried out in a measurement mode of the apparatus 10, during setup of the apparatus 10, or during maintenance of the apparatus 10. During the measurement, the apparatus 10 can be set to predefined process parameters, such as oxygen content of the atmosphere, temperature, etc. In particular, the measurement can be performed under build conditions (apparatus 10 is heated up, optical elements are heated up, gas stream as during build process).

According to the technique discussed above, it may be possible to easily calibrate a lateral shift that may occur when an optical unit is set to different optical configurations. In this way, a quality of a produced work piece can be increased.

1-15. (canceled)

16. A method for calibrating a position of a laser beam in an apparatus comprising at least one optical unit for directing the laser beam, the at least one optical unit comprising a plurality of optical elements, the method comprising:
setting a first optical configuration for the plurality of optical elements of the at least one optical unit and thereby directing the laser beam onto a measurement plane with a first focus spot size;
measuring a first position within the measurement plane, of the laser beam generated with the first optical configuration;
setting a second optical configuration for the plurality of optical elements of the at least one optical unit and thereby directing the laser beam onto the measurement plane with a second focus spot size different from the first focus spot size;
measuring a second position within the measurement plane, of the laser beam generated with the second optical configuration; and
determining at least one correction value based on the measured first position and the measured second position.

17. The method of claim 16, wherein setting the first optical configuration for the plurality of optical elements of the at least one optical unit and/or setting the second optical configuration for the plurality of optical elements of the at least one optical unit comprises focusing the laser beam onto the measurement plane.

18. The method of claim 16, further comprising:
storing a first position data set based on the measured first position; and
storing a second position data set based on the measured second position,
wherein the determining comprises determining the at least one correction value based on the first position data set and the second position data set.

19. The method of claim 16, further comprising:
applying the at least one correction value during use of the apparatus, such that a relationship between a position of the laser beam in the first optical configuration and a position of the laser beam in the second optical configuration is known.

20. The method of claim 16, further comprising:
determining at least one correction value for a third optical configuration by performing an interpolation or extrapolation on the basis of the at least one correction value.

21. The method of claim 16, wherein setting the second optical configuration for the plurality of optical elements of the at least one optical unit comprises changing a position of at least two optical elements, in particular, of at least two lenses.

22. The method of claim 16, further comprising:
while in the first optical configuration, irradiating the measurement plane according to a first irradiation pattern; and
while in the second optical configuration, irradiating the measurement plane according to a second irradiation pattern.

23. The method of claim 22 wherein the first irradiation pattern and the second irradiation pattern are irradiated onto at least one sensor positioned in the measurement plane.

24. The method of claim 22 wherein the first irradiation pattern and the second irradiation pattern are projected or burnt onto a foil or plate or powder layer positioned in the measurement plane.

25. The method of claim 24, further comprising:
before the step of measuring the first position and before the step of measuring the second position, observing the first irradiation pattern and the second irradiation pattern with the human eye and, based on the observing, deciding that the step of measuring the first position and the step of measuring the second position shall be carried out.

26. The method of claim 22, wherein the first irradiation pattern comprises a first circle and the second irradiation pattern comprises a second circle concentric to the first circle.

27. The method of claim 26, wherein the apparatus comprises a plurality of optical units and wherein a set of concentric circles is irradiated for each of the optical units.

28. The method of claim 16, wherein the second focus spot size is larger than the first focus spot size by a factor of at least 1.5, at least 2, at least 3, at least 4, at least 5, at least 6, at least 7, or at least 8.

29. The method of claim 16, wherein the apparatus is an apparatus for generating a three-dimensional work piece via selective laser sintering and/or selective laser melting and wherein the method further comprises:
irradiating a contour of a layer of a three-dimensional work piece with the first focus spot size; and
irradiating a core portion of the three-dimensional work piece within the contour with the second focus spot size larger than the first focus spot size,
wherein a position of the laser beam for irradiating at least one of the contour and the core portion is corrected by the at least one correction value.

30. A computer program product which, when carried out by a processor of an apparatus comprising at least one optical unit for generating a laser beam, the at least one optical unit comprising a plurality of optical elements, instructs the apparatus to carry out a method according to claim 16.
